(19) United States
(12) Patent Application Publication
(10) Pub. No.: US 2014/0260873 A1
(43) Pub. Date: Sep. 18, 2014

(54) SAW BLADE TENSION ADJUSTING APPARATUS FOR BAND SAW MACHINE

(71) Applicant: OAV EQUIPMENT & TOOLS, INC., Taichung City (TW)

(72) Inventors: Chiu-Hsiang LIN, Taichung City (TW); Hung-Chi CHEN, Shalu Township (TW)

(73) Assignee: OAV EQUIPMENT & TOOLS, INC., Taichung City (TW)

(21) Appl. No.: 13/800,230

(22) Filed: Mar. 13, 2013

(51) Int. Cl. B23D 55/10

(52) U.S. Cl. CPC B23D 55/10
USPC 83/816

(57) ABSTRACT

A saw blade tension adjusting apparatus of a band saw machine includes a retaining base, a movable base movably connected with the retaining base through two opposite sliding shafts, and a control unit having a handle and a cam connected with the handle so as to be driven to rotate between a tightening position and a loosening position. When the cam is located at the tightening position, the movable base is lifted by a large diameter portion of the cam to tighten the tension of a saw blade, and when the cam is located at the loosening position, the movable base is moved downwards to lean on a small diameter portion of the cam for loosening the tension of the saw blade.

### BACKGROUND OF THE INVENTION

1. Field of the Invention

The present invention relates generally to a band saw machine, and more specifically to a saw blade tension adjusting apparatus for a band saw machine that can provide high structural strength and ensure stable operation.

2. Description of the Related Art

Before using a band saw machine in cutting a workpiece, an operator needs to adjust the tension of a saw blade in advance for maintaining the cutting stability and extending the working life of the saw blade. As far as prior art is concerned, Taiwan Patent No. 491118 discloses a slide base and a wheel bracket connected with the slide base so as to be driven to move upwards or downwards by the actuation of the slide base. By this way, a driven wheel rotatably connected with the wheel bracket can be moved along with the wheel bracket for adjusting the tension of the saw blade running around the driven wheel.

However, the slide base of the aforesaid Taiwan patent has low structural strength because it is made of sheet metal with an inverted U-shaped section. Furthermore, an excessive gap exists between the inverted U-shaped slide base and the wheel bracket, such that vibrations may be generated at the driven wheel when the wheel bracket is moved downwards and displacements of the driven wheel may occur when the wheel bracket is moved upwards. Thus, it is desired to provide an improved saw blade tension adjusting apparatus for the band saw machine.

### SUMMARY OF THE INVENTION

It is one objective of the present invention to provide a saw blade tension adjusting apparatus for a band saw machine, which has the advantage of high structural strength and stable operation.

To achieve this objective of the present invention, the saw blade tension adjusting apparatus comprises a retaining base, a movable base having two opposite sliding shafts slidably inserted into the retaining base, a top plate connected with top ends of the sliding shafts, a bottom plate connected with bottom ends of the sliding shafts, and a wheel bracket mounted to the sliding shafts and located between the top and bottom plates. A control unit includes a handle and a cam connected with the handle such that the cam is driven by the handle to rotate relative to the movable base between a tightening position and a loosening position. When the cam is located at the tightening position, a large diameter portion of the cam pushes against the top plate of the movable base such that the movable base is moved upwards to tighten the tension of a saw blade. When the cam is located at the loosening position, the movable base is moved downwards to allow the top plate of the movable base to lean on a small diameter portion of the cam for releasing the tension of the saw blade.

Preferably, a fine-tuning unit is provided by the present invention, including a support plate slidably disposed between the sliding shafts of the movable base and located between the wheel bracket and the bottom plate of the movable base, a spiral spring disposed between the wheel bracket of the movable base and the support plate, a nut mounted on the bottom plate of the movable base, and a screw rod rotatably inserted into the bottom plate of the movable base, the support plate, and the spiral spring and having a threaded portion threaded with the nut. Thus, the movable base can be driven to move slightly by the rotation of the screw rod.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of a band saw machine equipped with a saw blade tension adjusting apparatus according to an embodiment of the prevent invention;

FIG. 2 is a perspective view of a driving wheel, a driven wheel, and a saw blade cooperated with the saw blade tension adjusting apparatus according to the embodiment of the prevent invention;

FIG. 3 is a perspective view of the saw blade tension adjusting apparatus according to the embodiment of the prevent invention;

FIG. 4 is a plan view of the saw blade tension adjusting apparatus according to the embodiment of the prevent invention, showing that the cam is located at the tightening position;

FIG. 5 is similar to FIG. 4, but showing that the cam is located at the loosening position; and

FIG. 6 is similar to FIG. 4, but showing that the fine adjustment of the movable base is completed.

### DETAILED DESCRIPTION OF THE INVENTION

As shown in FIGS. 1 and 2, a band saw machine 10 is equipped with a tension adjusting apparatus 20 in accordance with an embodiment of the present invention, comprising an upper case 11, a lower case 12, a driven wheel 13 rotatably mounted in the upper case 11, a driving wheel 14 rotatably mounted in the lower case 12, a saw blade 15 running around the driving wheel 14 and the driven wheel 13, and a motor 16 mounted with the lower case 12 and connected with the driving wheel 14. As shown in FIGS. 2 and 3, the tension adjusting apparatus 20 of the present invention is installed in the upper case 11 and comprises a retaining base 30, a movable base 40, and a control unit 50.

The retaining base 30 is fastened to the upper case 11 and provided with a first block 32 and two opposite second blocks 34 fastened to two sides of the first block 32.

The movable base 40 includes two opposite sliding shafts 41 slidably inserted into the first block 32 of the retaining base 30 such that the sliding shafts 41 are movable upwards and downwards relative to the retaining base 30, a top plate 42 connected with top ends of the sliding shafts 41 so as to be moved along with the sliding shafts 41, a bottom plate 43 connected with bottom ends of the sliding shafts 41 so as to be moved along with the sliding shafts 41, and a Wheel bracket 44 mounted on the sliding shafts 41 and located between the top and bottom plates 42 and 43 for connection of the driven wheel 13. By this way, the driven wheel 13 can be driven by the movement of the movable base 40 to move upwards and downwards relative to the retaining base 30.

The control unit 50 includes a handle 51 and a cam 52 fixedly sleeved on a rotating shaft 512 of the handle 51 and having a large diameter portion 522 and a small diameter portion 524 with a leaning plane 526, as shown in FIGS. 3 to 5, such that the cam. 52 is rotatable by the actuation of the handle 51 relative to the movable base 40. A block member 53 is fixed to the cam 52 and provided with one end protruding out of the periphery of the cam 52 for stopping the cam 52 to rotate when the block member 53 is interfered with the top plate 42 of the movable base 40.

When disassembling the saw blade 15, as shown in FIG. 5, an operator pulls down the handle 51 to enable the cam 52 to be rotated to a loosening position P1, such that the movable base 40 is moved downwards due to its own weight to lean on the leaning plane 526 of the small diameter portion 524 of the cam 52. Since the driven wheel 13 is moved downwards along with the wheel bracket 44 of the moveable base 40, a distance between the driven wheel 13 and the driving wheel 14 is reduced and therefore the tension of the saw blade 15 is released.

On the contrary, when assembling the saw blade 15, the operator pushes upwards the handle 51 to force the cam 52 to be rotated to a tightening position P2, as shown in FIGS. 3 and 4. At this time, the block member 53 is stopped against the top plate 42 of the movable base 40 to keep the cam 52 in location, and further, the large diameter portion 522 of the cam 52 pushes against the top plate 42 of the movable base 40. As a result, the movable base 40 is lifted by the cam 52 to enable the driven wheel 13 to be moved away from the driving wheel 14, thereby tightening the saw blade 15.

Besides, a fine-tuning unit 60 is provided by the present invention for adjusting the saw blade 15 to a suitable tension, including a support plate 61 slidably disposed between the sliding shafts 41 of the movable base 40 and located between the Wheel bracket 44 and the bottom plate 43, a spiral spring 62 disposed between the wheel bracket 44 of the movable base 40 and the support plate 61, a nut 63 mounted on the bottom plate 43 of the movable base 40, and a screw rod 64 rotatably inserted into the bottom plate 43 of the movable base 40, the support plate 61, and the spiral spring 62, and having a threaded portion 642 threaded with the nut 63. A thrust bearing 65 is mounted on the screw rod 64 and abutted against the bottom side of the support plate 61, and a handwheel 66 is connected with one end of the screw rod 64 and exposed out of the upper case 11 for driving the rotation of the screw rod 64.

When the screw rod 64 is rotated by the actuation of the handwheel 66, as shown in FIG. 6, the screw rod 64 is moved upwards along its axial direction because the nut 63 is stationary. During the movement of the screw rod 64, the support plate 61 is pushed by the thrust bearing 65, and then the spiral spring 62 is compressed by the support plate 61, and then the wheel bracket 44 is moved upwards by the elastic force of the spiral spring 62. By this way, the driven wheel 13 is moved slightly to complete the fine adjustment of the tension of the saw blade 15.

To deserve to be mentioned, two limiting rings 45 are fixedly sleeved on the sliding shafts 41 and adjacent to the top side of the wheel bracket 42 for restricting the upward movement of the wheel bracket 42. Furthermore, a tension meter 46 is pivotally connected with the upper case 11 and provided with a slot 462 for insertion of a protrusion 612 of the support plate 61, such that the tension meter 46 is pivotable along with the movement of the support plate 61 for measuring the tension of the saw blade 15, and the measured tension can be shown by a scale (not shown).

Above all, the tension of the saw blade 15 is adjusted by up-and-down movement of the movable base 40 through the two sliding shafts 41, and therefore the claimed invention has higher structural strength and provides more stable operation when compared with the prior art, thereby achieving the purpose of the present invention.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A saw blade tension adjusting apparatus for a band saw machine, comprising:
a retaining base;
a movable base having two opposite sliding shafts slidably inserted into the retaining base, a top plate connected with top ends of the sliding shafts, a bottom plate connected with bottom ends of the sliding shafts, and a wheel bracket mounted on the sliding shafts and located between the top and bottom plates; and
a control unit having a handle and a cam connected with the handle such that the cam is driven by the handle to rotate relative to the movable base between a tightening position where a large diameter portion of the cam is stopped against the top plate of the movable base, and a loosening position where a small diameter portion of the cam is abutted against the top plate of the movable base.

2. The saw blade tension adjusting apparatus as claimed in claim 1, wherein the control unit has a block member fixed to the cam and provided with one end protruding out of a periphery of the cam and stoppable against the top plate of the movable base for stopping the cam to rotate.

3. The tension adjusting apparatus as claimed in claim 1, wherein the small diameter portion of the cam has a leaning plane abutted against the top plate of the movable base when the cam is located at the loosening position.

4. The saw blade tension adjusting apparatus as claimed in claim 1, further comprising a fine-tuning unit including a support plate slidably disposed between the sliding shafts of the movable base and located between the wheel bracket and the bottom plate of the movable base, a spiral spring disposed between the wheel bracket of the movable base and the support plate, a nut mounted on the bottom plate of the movable base, and a screw rod rotatably inserted into the bottom plate of the movable base, the support plate, and the spiral spring, and having a threaded portion threaded with the nut.

5. The saw blade tension adjusting apparatus as claimed in claim 4, wherein the fine-tuning unit further has two limiting rings fixedly sleeved on the sliding shafts of the movable base respectively and adjacent to a top side of the wheel bracket of the moveable base.

6. The saw blade tension adjusting apparatus as claimed in claim 4, wherein the fine-tuning further has a handwheel connected with one end of the screw rod for driving the rotation of the screw rod.

7. The saw blade tension adjusting apparatus as claimed in claim 4, wherein the movable base has a tension meter with a slot for insertion of a protrusion of the support plate.

8. The saw blade tension adjusting apparatus as claimed in claim 4, wherein the fine-tuning unit has a thrust bearing mounted on the screw rod and abutted against a bottom side of the support plate.
